(19) United States
(12) Patent Application Publication
(10) Pub. No.: US 2021/0138785 A1
(43) Pub. Date: May 13, 2021

(54) INKJET RECORDING APPARATUS THAT EJECTS INK TO RECORDING MEDIUM AND RECORDS IMAGE

(71) Applicant: KYOCERA Document Solutions Inc., Osaka (JP)

(72) Inventors: Masanori OKADA, Osaka (JP); Hiroshi YAMASHITA, Osaka (JP)

(73) Assignee: KYOCERA Document Solutions Inc., Osaka (JP)

(21) Appl. No.: 17/095,549

(22) Filed: Nov. 11, 2020

(30) Foreign Application Priority Data
Nov. 11, 2019 (JP) 2019-204129

(51) Int. Cl. B41J 2/045; B41J 11/00; B41J 2/165

(52) U.S. Cl. CPC B41J 2/04573; B41J 2/16517; B41J 11/007

(57) ABSTRACT

Provided is an inkjet recording apparatus that avoids deterioration of the image quality of recorded images due to flushing without reducing productivity even when the recording medium is placed at a position deviated from the normal position with respect to the opening of the transport belt. In the control unit of the inkjet recording apparatus, at least one recording medium is placed between two opening groups located in a preset pattern on a transport belt. In addition, based on the detection result of the second detection sensor, the recording medium supply unit supplies a plurality of recording media to the transport belt so that a tip of the leading recording medium is located at a specific position with respect to a reference opening group on the transport belt. This first control is performed.

### INCORPORATION BY REFERENCE

This application is based on and claims the benefit of priority from Japanese Patent Application No. 2019-204129 filed on Nov. 11, 2019, the contents of which are hereby incorporated by reference.

### BACKGROUND

The present disclosure relates to an inkjet recording apparatus that discharges ink onto a recording medium and records an image.

Typically, in an inkjet recording apparatus such as an inkjet printer, flushing (empty ejection) in which ink is periodically ejected from the nozzle is performed in order to reduce or prevent clogging of the nozzle due to drying of the ink. For example, in an inkjet recording apparatus of a typical technology, it is made that an opening is provided in a transport belt for transporting paper, and when the opening comes to a position facing the recording head due to the running of the transport belt, ink is ejected from a nozzle of the recording head and is passed through the opening. In particular, by recognizing the position of the opening based on the detection result of the mark provided on the transport belt and controlling the ejection of ink in flushing, deformation such as elongation of the transport belt is taken into consideration with respect to the opening. The ink is allowed to pass through more accurately.

### SUMMARY

In order to achieve the above object, the inkjet recording apparatus according to one aspect of the present disclosure includes a recording head, a control unit, an endless transfer belt, a recording medium supply unit, a first detection sensor, and a second detection sensor. The recording head has a plurality of nozzles for ejecting ink. The control unit causes the recording head to perform flushing to eject the ink at a timing different from the timing that contributes to image formation on the recording medium. The endless transport belt conveys the recording medium to a position facing the recording head and has an opening group, which includes an opening that passes through the ink ejected from each nozzle of the recording head during the flushing, at a plurality of locations in the transport direction of the recording medium. The recording medium supply unit supplies the recording medium to the transport belt. The first detection sensor detects the passage of the recording medium supplied to the transport belt by the recording medium supply unit. The second detection sensor detects the passage of at least one of the openings by the traveling of the transport belt. The control unit performs a first control and a second control. a first control is supplying a plurality of recording media to the transport belt by the recording medium supply unit based on the detection result of the second detection sensor so that at least one recording medium is placed between two openings located in a preset pattern on the transport belt and a tip of a leading recording medium comes to a specific position with respect to a reference opening group on the transport belt. a second control is determining whether or not the tip of the leading recording medium actually supplied to the transport belt is at the specific position with respect to the reference opening group based on the detection results of the first detection sensor and the second detection sensor, and it is controlling the flushing by the recording head based on the determination result.

### BRIEF DESCRIPTION OF THE DRAWINGS

FIG. 1 is an explanatory diagram showing a schematic configuration of a printer as an inkjet recording apparatus according to an embodiment of the present disclosure;

FIG. 2 is a plan view of a recording unit included in the printer;

FIG. 3 is an explanatory diagram schematically showing a configuration around a paper transport path from the paper feed cassette of the printer to the second transport unit via the first transport unit;

FIG. 4 is a block diagram showing a hardware configuration of a main part of the printer;

FIG. 5 is an explanatory diagram schematically showing regions having different suction forces in the first transport unit;

FIG. 6 is an explanatory diagram schematically showing a configuration example of the first transport unit;

FIG. 7 is an explanatory diagram schematically showing another configuration example of the first transport unit;

FIG. 8 is a plan view showing a configuration example of the first transport belt included in the first transport unit;

FIG. 9 is explanatory drawing schematically showing an example of a pattern of an opening group for flushing when the first transport belt of FIG. 8 is used, and a paper arranged on the first transport belt according to the pattern;

FIG. 10 is an explanatory diagram schematically showing another example of the pattern and the paper arranged on the first transport belt according to the pattern;

FIG. 11 is an explanatory diagram schematically showing still another example of the pattern and the paper arranged on the first transport belt according to the pattern;

FIG. 12 is an explanatory diagram schematically showing still another example of the pattern and the paper arranged on the first transport belt according to the pattern;

FIG. 13 is a plan view showing another configuration example of the first transport belt;

FIG. 14 is an explanatory diagram schematically showing an example of the above pattern when the first conveying belt of FIG. 13 is used, and the paper arranged on the first conveying belt according to the pattern;

FIG. 15 is an explanatory diagram schematically showing another example of the pattern and the paper arranged on the first transport belt according to the pattern;

FIG. 16 is an explanatory diagram schematically showing still another example of the pattern and the paper arranged on the first transport belt according to the pattern;

FIG. 17 is an explanatory diagram schematically showing still another example of the pattern and the paper arranged on the first transport belt according to the pattern;

FIG. 18 is an explanatory view showing a state in which the paper is placed on the first transport belt at a position deviated from the regular position;

FIG. 19 is a flowchart showing an operation flow according to an example of flushing control;

FIG. 20 is an explanatory diagram showing the detection timing of each sensor included in the printer;

FIG. 21 is a flowchart showing an operation flow according to another example of the flushing control;

FIG. 22 is an explanatory diagram showing an example of an opening group used when flushing is performed by the above flushing control;

FIG. 23 is an explanatory diagram showing an example of an opening group and an opening row used when flushing is performed by the above flushing control;

FIG. 24 is explanatory drawing showing an example of an opening group by using a configuration of the transport belt as shown in FIG. 13 and is used in case of performing a flushing between papers when the leading paper is placed in a regular position with respect to the reference opening group;

FIG. 25 is explanatory drawing showing an example of an opening group by using a configuration of the transport belt as shown in FIG. 13 and is used in case of performing a flushing between papers when the leading paper is placed at a position deviated from a normal position with respect to the reference opening group;

FIG. 26 is a flowchart showing an operation flow according to still another example of the flushing control;

FIG. 27 is a flowchart showing an operation flow according to still another example of the flushing control; and

FIG. 28 is a flowchart showing an operation flow according to still another example of the flushing control.

### DETAILED DESCRIPTION

[1. Configuration of Inkjet Recording Apparatus]

Hereinafter, an embodiment of the present disclosure is described with reference to the drawings. FIG. 1 is an explanatory diagram showing a schematic configuration of a printer 100 as an inkjet recording apparatus according to an embodiment of the present disclosure. The printer 100 includes a paper feed cassette 2, which is a paper storage unit. The paper cassette 2 is arranged lower part of the inside of the printer main body 1. A paper P, which is an example of a recording medium, is housed inside the paper cassette 2.

The paper feed device 3 is arranged on the downstream side of the paper feed cassette 2 in the paper transport direction, that is, above the right side of the paper feed cassette 2 in FIG. 1. By the paper feeding device 3, the paper P is separated and sent out one by one toward the upper right side of the paper feed cassette 2 in FIG. 1.

The printer 100 includes a first paper transport path 4a inside. The first paper transport path 4a is located on the upper right side of the paper feed cassette 2 in the paper feed direction. The paper P sent out from the paper feed cassette 2 is vertically upwardly conveyed along the side surface of the printer main body 1 by the first paper conveying path 4a.

A resist roller pair 13 is provided at the downstream end of the first paper transport path 4a in the paper transport direction. Further, the first transport unit 5 and the recording unit 9 are arranged in the immediate vicinity of the resist roller pair 13 on the downstream side in the paper transport direction. The paper P sent out from the paper feed cassette 2 reaches the resist roller pair 13 through the first paper transport path 4a. The resist roller pair 13 corrects the oblique feed of the paper P, measures the timing with the ink ejection operation executed by the recording unit 9, and feeds the paper P toward the first transport unit 5.

The paper P fed to the first transport unit 5 is transported by the first transport belt 8 (as refer to FIG. 2) to a position facing the recording unit 9 (particularly, the recording heads 17a to 17c as described later). An image is recorded on the paper P by ejecting ink from the recording unit 9 onto the paper P. At this time, the ink ejection in the recording unit 9 is controlled by the control unit 110 inside the printer 100. The control unit 110 is configured to, for example, a CPU (Central Processing Unit).

In the paper transport direction, the second transport unit 12 is arranged on the downstream side (left side in FIG. 1) of the first transport unit 5. The paper P on which the image is recorded by the recording unit 9 is sent to the second transport unit 12. The ink ejected onto the surface of the paper P is dried while passing through the second transport unit 12.

In the paper transport direction, a decurler unit 14 is provided on the downstream side of the second transport unit 12 and near the left side surface of the printer main body 1. The paper P, which the ink has been dried by the second transport unit 12, is sent to the decurler unit 14, and the curl generated on the paper P is corrected.

A second paper transport path 4b is provided on the downstream side (upper side of FIG. 1) of the decurler unit 14 in the paper transport direction. When double-sided recording is not performed, the paper P that has passed through the decurler unit 14 passes through the second paper transport path 4b and is discharged to the paper ejection tray 15 provided outside the left side surface of the printer 100.

An inversion transport path 16 for double-sided recording is provided above the recording unit 9 and the second transport unit 12 in the upper part of the printer main body 1. When double-sided recording is performed, the paper P, which has passed through the second transport unit 12 and the decurler unit 14 after completion of the recording on one side (first side) of the paper, is sent to the transport path 16 through the second paper transport path 4b.

The paper P sent to the reverse transport path 16 is subsequently switched in the transport direction for recording on the other side (second side) of the paper P. Then, the paper P passes through the upper part of the printer main body 1 and is fed toward the right side, and it is fed to the first transport unit 5 again in a state where the second side is facing upward through the resist roller pair 13. In the first transfer unit 5, the paper P is conveyed to a position facing the recording unit 9, and an image is recorded on the second surface by ejecting ink from the recording unit 9. The paper P after double-sided recording is discharged to the paper discharge tray 15 via the second transport unit 12, the decurler unit 14, and the second paper transport path 4b in this order.

Further, a maintenance unit 19 and a cap unit 20 are arranged below the second transport unit 12. The maintenance unit 19 moves horizontally below the recording unit 9 when executing purging, wipes the ink extruded from the ink ejection port of the recording head, and collects the wiped ink. In addition, the purge refers to an operation of forcibly pushing out ink from the ink ejection port of the recording head in order to eject thickened ink, foreign matter, and air bubbles in the ink ejection port. When capping the ink ejection surface of the recording head, the cap unit 20 horizontally moves below the recording unit 9, further moves upward, and is mounted on the lower surface of the recording head.

FIG. 2 is a plan view of the recording unit 9. The recording unit 9 includes a head housing 10 and line heads 11Y, 11M, 11C, and 11K. The line heads 11Y to 11K are held in the head housing 10 at a height at which a specific interval (for example, 1 mm) is formed with respect to the transport surface of the endless first transport belt 8 stretched on a plurality of rollers including the drive roller 6a, the driven roller 6b, and the other rollers 7.

The line heads 11Y to 11K each have a plurality of (here, three) recording heads 17a to 17c. The recording heads 17a to 17c are arranged in a staggered manner along the paper width direction (arrow BB′ direction) orthogonal to the paper transport direction (arrow A direction). The recording heads 17a to 17c have a plurality of ink ejection ports 18 (nozzles). The ink ejection ports 18 are arranged side by side at equal intervals in the width direction of the recording head, that is, in the paper width direction (arrow BB′ direction). From the line head 11Y to 11K, through ink discharge ports 18 of the recording heads 17a to 17c, inks of each color of yellow (Y), magenta (M), cyan (C), and black (K) are ejected toward the paper P transported by the first transport belt 8.

FIG. 3 schematically shows a configuration around a transport path of the paper P from the paper feed cassette 2 to the second transport unit 12 via the first transport unit 5. Further, FIG. 4 is a block diagram showing a hardware configuration of a main part of the printer 100. In addition to the above configuration, the printer 100 further includes a resist sensor 21, a first paper sensor 22, a second paper sensor 23, and belt sensors 24 and 25.

The resist sensor 21 detects the paper P that is conveyed from the paper cassette 2 by the paper feeding device 3 and sent to the resist roller pair 13. The control unit 110 can control the rotation start timing of the resist roller pair 13 based on the detection result of the resist sensor 21. For example, the control unit 110 can control the supply timing of the paper P to the first transport belt 8 after the skew (diagonally transporting) correction by the resist roller pair 13 based on the detection result of the resist sensor 21.

The first paper sensor 22 is a line sensor that detects the position of the paper P sent from the resist roller pair 13 to the first transport belt 8 in the width direction. The control unit 110, based on the detection result of the first paper sensor 22, makes ink eject from the ink ejection port 18 corresponding to the width of the paper P among the ink ejection ports 18 of the recording heads 17a to 17c of the line heads 11Y to 11K, and an image can be recorded on paper P.

The second paper sensor 23 is a first detection sensor that detects the passage of the paper P supplied to the first transport belt 8 by the resist roller pair 13 as the recording medium supply unit. That is, the second paper sensor 23 detects the position of the paper P transported by the first transport belt 8 in the transport direction. The second paper sensor 23 is located on the upstream side of the recording unit 9 and on the downstream side of the first paper sensor 22 in the paper transport direction. Based on the detection result of the second paper sensor 23, the control unit 110 can control the ink ejection timing for paper P that reaches a position facing the line heads 11Y to 11K (recording heads 17a to 17c) by the first transport belt 8.

The belt sensors 24 and 25 detect the positions of a plurality of opening groups 82 (as refer to FIG. 8) provided on the first transport belt 8. That is, the belt sensors 24 and 25 are second detection sensors that detect the passage of at least one of the opening group 82 due to the traveling of the first transport belt 8. The belt sensor 24 is located on the downstream side of the recording unit 9 in the paper transport direction (traveling direction of the first transport belt 8). The belt sensor 25 is located between the driven roller 6b that stretches the first transport belt 8 and the other rollers 7. The driven roller 6b is located on the upstream side of the first transport belt 8 in the traveling direction with respect to the recording unit 9. In addition, the belt sensor 24 has the same function as the second paper sensor 23. The control unit 110 can control the resist roller pair 13 so as to supply the paper P to the first transport belt 8 at a specific timing based on the detection result of the belt sensor 24 or 25.

Further, the position of the paper is detected by a plurality of sensors (second paper sensor 23, belt sensor 24), and the position of the opening group 82 of the first transport belt 8 is detected by a plurality of sensors (belt sensors 24 and 25). As a result, it is possible to correct the error of the detected position and detect an abnormality.

The first paper sensor 22, the second paper sensor 23, and the belt sensors 24 and 25 as described above may be configured to a transmissive or reflective optical sensor and a CIS sensor (Contact Image Sensor). Further, a mark corresponding to the position of the opening group 82 is formed at the end of the first transport belt 8 in the width direction, and the position of the opening group 82 may be detected by the belt sensors 24 and 25 by detecting the mark.

In addition, the printer 100 may be provided with a meandering detection sensor that detects the meandering of the first conveying belt 8, and it may be configured to correct the meandering of the first conveying belt 8 based on the detection result.

Also, the printer 100 further includes an operation panel 27, a storage unit 28, and a communication unit 29. The operation panel 27 is an operation unit for receiving various setting inputs by the user. For example, the user can operate the operation panel 27 to input information on the size of the paper P to be set in the paper feed cassette 2, that is, the size of the paper P to be conveyed by the first transfer belt 8. The storage unit 28 is a memory that stores the operation program of the control unit 110 and various information, and it is configured with including a ROM (Read Only Memory), a RAM (Random Access Memory), a non-volatile memory, and the like. The information set by the operation panel 27 (for example, the size information of the paper P) is stored in the storage unit 28. The communication unit 29 is a communication interface for transmitting and receiving information to and from an external apparatus (for example, a personal computer (PC)). For example, when a user operates a PC and sends a print command to the printer 100 together with image data, the above image data and the print command are input to the printer 100 via the communication unit 29. In the printer 100, the control unit 110 controls the recording heads 17a to 17c based on the image data to eject ink so that the image can be recorded on the paper P.

Further, as shown in FIG. 3, the printer 100 has ink receiving units 31Y, 31M, 31C, and 31K on the inner peripheral surface side of the first transport belt 8. When flushing is executed by the recording heads 17a to 17c, the ink receiving units 31Y to 31K receives and collects the ink, which is ejected from the recording heads 17a to 17c and passed through the opening 80 (see FIG. 8) of the opening group 82 as described later in the first transport belt 8. Therefore, the ink receiving units 31Y to 31K are provided at positions facing the recording heads 17a to 17c of the line heads 11Y to 11K via the first transport belt 8. In addition, the ink collected by the ink receiving units 31Y to 31K is sent to, for example, a waste ink tank and discarded. However, the ink may be reused without being discarded.

Here, flushing is referred to eject ink at a timing different from the timing that contributes to image formation (image recording) on the paper P for the purpose of reducing or preventing clogging of the ink ejection port 18 due to ink drying. The execution of flushing in the recording heads 17a to 17c is controlled by the control unit 110.

The second transport unit 12 described above includes a second transport belt 12a and a dryer 12b. The second transport belt 12a is stretched by two driving rollers 12c and a driven roller 12d. The paper P, which is transported by the first transport unit 5 and is recorded an image by ink ejection by the recording unit 9, is transported by the second transport belt 12a, dried by the dryer 12b during the transporting, and transported to the decurler unit 14 as described above.

[2. Details of the First Transport Unit]

(2-1. Example of Configuration of the First Transport Unit)

In the present embodiment, a negative pressure suction method is adopted as a method for transporting the paper P in the first transport unit 5. The negative pressure suction method is a method in which the paper P is attracted to the first transport belt 8 by negative pressure suction and transported.

Here, as described above, the ink receiving units 31Y to 31K are provided at positions facing the recording heads 17a to 17c of the line heads 11Y to 11K via the first transport belt 8. A case where the suction force of the region where the ink receiving units 31Y to 31K are provided is strong at the time of negative pressure suction is described. In this case, the ink ejected from the recording heads 17a to 17c during flushing vigorously passes through the opening 80 of the first transport belt 8 and collides with the liquid surface of the ink already contained in the ink receiving units 31Y to 31K. In some cases, mist that scatters ink may be generated around. When the mist is generated, the scattered ink adheres to the inner peripheral surface of the first transport belt 8 and stains the inner peripheral surface. As a result, the surface of the roller on which the first transport belt 8 is stretched may become dirty, causing uneven transport (for example, meandering or slipping) of the first transport belt 8.

Therefore, in the present embodiment, as shown in FIG. 5, the suction force in the region where the ink receiving units 31Y to 31K are provided, that is, the region facing the line heads 11Y to 11K via the first transport belt 8, becomes weaker than the regions on the upstream side and the downstream side in the paper transport direction. As a result, the above-mentioned inconvenience caused by mist is reduced. Specifically, regions having different suction forces are generated by the following configurations.

FIG. 6 is an explanatory diagram schematically showing a configuration example of the first transport unit 5. The first suction chambers 51a to 51e and the second suction chambers 52a to 52d are provided on the inner peripheral surface side of the first transport belt 8 of the first transport unit 5. The first suction chambers 51a to 51e and the second suction chambers 52a to 52d are formed in a long shape in the belt width direction of the first transport belt 8. The first suction chambers 51a to 51e and the second suction chambers 52a to 52d are open on the side facing the first transfer belt 8.

The first suction chambers 51a to 51e are provided in this order from the downstream side to the upstream side in the paper transport direction (A direction). The second suction chamber 52a is provided between the first suction chamber 51a and the first suction chamber 51b at positions facing the line head 11Y via the first transport belt 8. The second suction chamber 52b is provided between the first suction chamber 51b and the first suction chamber 51c at a position facing the line head 11M via the first transfer belt 8. The second suction chamber 52c is provided between the first suction chamber 51c and the first suction chamber 51d at a position facing the line head 11C via the first transfer belt 8. The second suction chamber 52d is provided between the first suction chamber 51d and the first suction chamber 51e at positions facing the line head 11K via the first transfer belt 8. The ink receiving units 31Y to 31K described above are arranged in the second suction chambers 52a to 52d, respectively.

The insides of the first suction chambers 51a to 51e and the second suction chambers 52a to 52d are sucked by the suction member 53. The suction member 53 sucks the paper P onto the first transport belt 8 by negative pressure suction. Such a suction member 53 is configured to, for example, a fan or a compressor. In the present embodiment, the insides of the first suction chamber 51a and the second suction chamber 52a are sucked by the common suction member 53. Further, the inside of the first suction chamber 51b and the second suction chamber 52b is sucked by the common suction member 53. Similarly, the insides of the first suction chamber 51c and the second suction chamber 52c are sucked by the common suction member 53, and the insides of the first suction chamber 51d and the second suction chamber 52d are sucked by the common suction member 53. The first suction chamber 51e is independently sucked by the suction member 53.

Filters 54 are arranged in the first suction chambers 51a to 51e, respectively, and filters 55 are arranged in the second suction chambers 52a to 52d, respectively. Therefore, when each suction member 53 is driven, the inside of the first suction chambers 51a to 51e is sucked through the filter 54, and the inside of the second suction chambers 52a to 52d is sucked through the filter 55. Thus, the inside of the first suction chamber 51a to 51e and a second suction chamber 52a to 52d becomes a negative pressure, air is sucked through the suction holes 8a (as refer to FIG. 8) or the opening group 82 provided in the first transport belt 8, and the paper P is transported while being attracted to the first transport belt 8.

Here, the filter 54 has a coarser mesh than the filter 55. Therefore, the resistance of the air passing through the filter 54 is lower than the resistance of the air passing through the filter 55. Therefore, when each suction member 53 is driven with the same driving force, the inside of the first suction chambers 51a to 51e is sucked with a relatively strong suction force, and the inside of the second suction chambers 52a to 52d is sucked with a relatively weak suction force. Therefore, the speed at which the ink ejected from the recording heads 17a to 17c during flushing passes through the opening 80 of the first transport belt 8 is reduced, and it is possible to reduce ink scattering (mist) due to collision with the liquid surface of the ink accumulated in the ink receiving units 31Y to 31K. Thereby, the above-mentioned inconvenience caused by the mist can be reduced.

(2-2. Another Configuration Example of the First Transport Unit)

FIG. 7 is an explanatory diagram schematically showing another configuration example of the first transport unit 5. In the first transfer unit 5 of FIG. 7, the same filter 54 is arranged in the first suction chambers 51a to 51e and the second suction chambers 52a to 52d as shown in FIG. 6, and the first suction chambers 51a to 51e and the second suction chambers 52a to 52d are configured to be sucked by separate suction members 53. In such a configuration, the driving force of each suction member 53 that sucks the inside of the second suction chambers 52a to 52d is switched, and thus the suction force of the second suction chambers 52a to 52d is switched between strong suction and weak suction. In addition, the drive of each suction member 53 is controlled by, for example, the control unit 110.

For example, when ink is ejected to the paper P conveyed by the first transfer belt 8 (at the time of image recording), all the suction members 53 that suck the first suction chambers 51a to 51e and the second suction chambers 52a to 52d are driven by the first driving force. On the other hand, at the time of flushing, while driving each suction member 53 that sucks the first suction chambers 51a to 51e with the first driving force, and each suction member 53 that sucks the second suction chambers 52a to 52d is driven by a second driving force lower than the first driving force. As a result, at the time of image recording, the first suction chambers 51a to 51e and the second suction chambers 52a to 52d are sucked by strong suction to convey the paper P, at the time of flushing, only the second suction chambers 52a to 52d are weakly sucked, and thus the mist can be reduced. Thereby, the above-mentioned inconvenience caused by the mist can be reduced.

In addition, instead of using the filter 54 or 55, the diameter of the pipe (flow path cross-unital area) serving as the flow path of the air sucked from the first suction chambers 51a to 51e and the second suction chambers 52a to 52d may be able to be different. As a result, the suction forces can be made different between the first suction chambers 51a to 51e and the second suction chambers 52a to 52d.

[3. Details of the First Transport Belt]

(3-1. Example of Configuration of the First Transport Belt)

Next, the details of the first transport belt 8 of the first transport unit 5 is described. FIG. 8 is a plan view showing a configuration example of the first transport belt 8. In the present embodiment, as described above, the paper P is conveyed by the negative pressure suction method. Therefore, as shown in the figure, the first transport belt 8 is provided with innumerable suction holes 8a for passing suction air generated by negative pressure suction of the suction member 53.

Further, the first transport belt 8 is also provided with an opening group 82. The opening group 82 is a set of openings 80 through which ink discharged from each nozzle (ink ejection port 18) of the recording heads 17a to 17c is passed during flushing. The opening area of the opening 80 is larger than the opening area of the suction hole 8a. The first transport belt 8 has a plurality of opening groups 82 in the transport direction (A direction) of the paper P in one cycle, and the present embodiment has six. In addition, if the opening groups 82 are distinguished from each other, the six opening groups 82 are referred to as opening groups 82A to 82F from the downstream side in the A direction. The suction hole 8a is located between the opening group 82 and the opening group 82 that are adjacent to each other in the A direction. That is, in the first transport belt 8, the suction hole 8a is not formed in the region overlapping the opening group 82.

The opening group 82 is irregularly located in the A direction in one cycle of the first transport belt 8. That is, in the A direction, the distance between the adjacent opening group 82 and the opening group 82 is not constant but changes (there are at least two types of the above distances). At this time, the maximum distance between the two opening groups 82 adjacent to each other in the A direction (for example, the distance between the opening group 82A and the opening group 82B in FIG. 8) is longer than the length of the paper P in the A direction when paper P of the minimum printable size (for example, A4 size (horizontal placement)) is placed on the first transport belt 8.

The opening group 82 has an opening row 81. The opening row 81 is configured by arranging a plurality of openings 80 in the belt width direction (paper width direction, BB′ direction) orthogonal to the A direction. One opening group 82 has at least one opening row 81 in the A direction, and in the present embodiment, it has two rows of opening rows 81. In addition, when distinguishing the two rows of opening rows 81 from each other, one is referred to as the opening row 81a and the other is referred to as the opening row 81b.

In one opening group 82, the opening 80 of any opening row 81 (for example, opening row 81a) is located offset from the opening 80 of the other opening row 81 (for example, the opening row 81b) in the BB′ direction. Moreover, the opening 80 is positioned so as to overlap a part of the opening 80 of another opening row 81 (for example, the opening row 81b) when viewed in the A direction. Further, in each opening row 81, the plurality of openings 80 are located at equal intervals in the BB′ direction.

By arranging the plurality of opening rows 81 in the A direction to form one opening group 82 as described above, the width of the opening group 82 in the BB′ direction is larger than the width of the recording heads 17a to 17c in the BB′ direction. Therefore, the opening group 82 covers the entire ink ejection region in the BB′ direction of the recording heads 17a to 17c, and the ink ejected from all the ink ejection ports 18 of the recording heads 17a to 17c during flushing passes through any opening 80 of the opening group 82.

(3-2. Pattern of Opening Group Used for Flushing)

In the present embodiment, the control unit 110 drives the recording heads 17a to 17c while transporting the paper P by using the first transport belt 8 to record an image on the paper P. This is based on image data transmitted from the outside (for example, a PC). At that time, clogging of the ink ejection port 18 is reduced or prevented by causing the recording heads 17a to 17c to perform flushing between the transported paper P and the paper P (flushing between papers).

Here, in the present embodiment, in one cycle of the first transport belt 8, the control unit 110 determines a pattern (combination) of a plurality of opening groups 82 used for flushing in the A direction according to the size of the paper P to be used. The size of the paper P to be used can be recognized by the control unit 110 based on the information stored in the storage unit 28 (size information of the paper P input by the operation panel 27).

FIGS. 9 to 12 show an example of the above pattern for each paper P, respectively. For example, when the paper P to be used is A4 size (horizontal placement) or letter size (horizontal placement), the control unit 110 selects the pattern of the opening group 82 as shown in FIG. 9. That is, the control unit 110 selects the opening groups 82A, 82C, and 82F as the opening group 82 used for flushing from the six opening groups 82 as shown in FIG. 8. When the paper P used is A4 size (vertical placement) or letter size (vertical placement), as shown in FIG. 10, the control unit 110 selects the opening groups 82A and 82D as the opening group 82 used for flushing from the six opening groups 82. When the paper P used is A3 size, B4 size or legal size (all vertically placement), as shown in FIG. 11, the control unit 110 selects the opening groups 82A, 82B, and 82E as the opening group 82 used for flushing from the six opening groups 82. When the paper P used is 13 inches×19.2 inches in size, as shown in FIG. 12, the control unit 110 selects the opening groups 82A and 82D as the opening group 82 used for flushing from the six opening groups 82. In addition, in each drawing, the opening 80 of the opening group 82 adopting to the above pattern is shown in black for convenience.

Then, the control unit 110 causes the recording heads 17a to 17c to perform flushing at the timing when the opening group 82 located in the determined pattern faces the recording heads 17a to 17c by the traveling of the first transport belt 8. Here, the traveling speed of the first transport belt 8 (paper transport speed), the distance between the opening groups 82A to 82E, and the positions of the recording heads 17a to 17c with respect to the first transport belt 8 are all definite. Therefore, when the belt sensor 24 or 25 detects that the reference opening group 82 (for example, the opening group 82A) has passed by the traveling of the first transport belt 8, how many seconds after the detection time that the opening groups 82A to 82E pass the position facing the recording heads 17a to 17c can be determined. Therefore, the control unit 110 can cause the recording heads 17a to 17 to perform flushing based on the detection result of the belt sensor 24 or 25 at the timing when the opening group 82 located in the pattern determined above faces the recording heads 17a to 17c.

At this time, the control unit 110, based on the detection result of the belt sensor 24 or 25, for each class determined according to the size of the paper P, controls flushing in the recording heads 17a to 17c so that the ink passes through the same opening group 82 in each cycle of the first transport belt 8.

For example, a case where the paper P to be used is A4 size (horizontal placement) or letter size (horizontal placement) is described (first class). In this case, the control unit 110 controls flushing in the recording heads 17a to 17c so that the ink passes through the same opening groups 82A, 82C, and 82F as shown in FIG. 9 in each cycle of the first transport belt 8. The case where the paper P to be used is A4 size (vertical placement) or letter size (vertical placement) is described (second class). In this case, the control unit 110 controls flushing in the recording heads 17a to 17c so that the ink passes through the same opening groups 82A and 82D as shown in FIG. 10 in each cycle of the first transport belt 8. The case where the paper P to be used is A3 size, B4 size or legal size (all vertically placement) is described (third class). In this case, the control unit 110 controls flushing in the recording heads 17a to 17c so that the ink passes through the same opening groups 82A, 82B, 82E as shown in FIG. 11 in each cycle of the first transport belt 8. A case where the paper P to be used has a size of 13 inches×19.2 inches is described (fourth class). In this case, the control unit 110 controls flushing in the recording heads 17a to 17c so that the ink passes through the same opening groups 82A and 82D as shown in FIG. 12 in each cycle of the first transport belt 8.

Further, the control unit 110 controls the supply of the paper P to the first transport belt 8 so as to deviate in the A direction from the opening group 82 located in the determined pattern. That is, the control unit 110 supplies the paper P on the first transport belt 8 by the resist roller pair 13 as the recording medium supply unit between the plurality of opening groups 82 arranged in the A direction in the above pattern.

For example, a case where the paper P to be used is A4 size (horizontal placement) or letter size (horizontal placement) is described. In this case, as shown in FIG. 9, on the first transport belt 8, the control unit 110 controls the resist roller pair 13 to supply the paper P to the first transport belt 8 at a specific supply timing so that two sheets of paper P are arranged between the opening group 82A and the opening group 82C on the first transport belt 8, two sheets of paper P are arranged between the opening group 82C and the opening group 82F, and one sheet of paper P is arranged between the opening group 82F and the opening group 82A. At this time, the control unit 110 arranges each paper P on the first transport belt 8 at a position separated from the opening groups 82A, 82C, 82F located in the above pattern in the A direction by a specific distance or more. The resist roller pair 13 is controlled to supply the paper pattern P to the first transport belt 8. The A direction includes both the upstream side and the downstream side. In addition, the specific distance is set to 10 mm as an example here.

Here, the supply timing of the paper P by the resist roller pair 13 can be determined by the control unit 110 based on the detection result of the belt sensor 24 or 25. For example, when the belt sensor 24 or 25 detects that the reference opening group 82 (for example, the opening group 82A) has passed due to the traveling of the first transport belt 8, it is possible to determine whether the paper P can be arranged at each position as shown in FIG. 9. This is a case where the control unit 110 supplies the paper P to the first transport belt 8 by the resist roller pair 13 several seconds after the detection time. Therefore, the control unit 110 determines the supply timing of the paper P based on the detection result of the belt sensor 24 or 25, and it controls the resist roller pair 13 so that the paper P is supplied at the determined supply timing. As a result, the paper P can be arranged at each position as shown in FIG. 9 on the first transport belt 8 at approximately equal intervals. In the example of FIG. 9, five sheets of paper P can be transported in one cycle of the first transport belt 8, and 150 ipm (images per minute) can be realized as the number of prints (productivity) per minute of the paper P.

Further, as shown in FIG. 9, when the A4 size (horizontal placement) paper P is supplied to the first transport belt 8, only one sheet of paper P is supplied between the opening group 82F and the opening group 82A of the first transport belt 8. In this case, the control unit 110 controls the resist roller pair 13 based on the detection result of the belt sensor 24 or 25 so that the center Po in the A direction of the paper P is located at the intermediate position 8m between the opening group 82F and the opening group 82A. Then, the paper P is supplied from the resist roller pair 13 to the first transport belt 8.

On the other hand, a case where the paper P to be used is A4 size (vertical placement) or letter size (vertical placement) is described. In this case, the control unit 110, as shown in FIG. 10, controls the resist roller pair 13 to supply the paper P to the first transport belt 8 at a specific supply timing so that two sheets of paper P are arranged between the opening group 82A and the opening group 82D on the first transport belt 8, and two sheets of paper P are arranged between the opening group 82D and the opening group 82A. In the example of FIG. 10, four sheets of paper P can be transported in one cycle of the first conveying belt 8, and a productivity of 120 ipm can be achieved.

A case where the paper P to be used is A3 size, B4 size or legal size (all vertical placement) is described.

In this case, the control unit 110 controls, as shown in FIG. 11, on the first transport belt 8, the resist roller pair 13 to supply the paper P to the first transport belt 8 at a specific supply timing so that one sheet of paper P is arranged between the opening group 82A and the opening group 82B, one sheet of paper P is arranged between the opening group 82B and the opening group 82E, and one sheet of paper P is arranged between the opening group 82E and the opening group 82A. In the example of FIG. 11, three sheets of paper P can be transported in one cycle of the first conveying belt 8, and a productivity of 90 ipm can be achieved. In addition, the control unit 110 controls the resist roller pair 13 based on the detection result of the belt sensor 24 or 25 so that the center of one sheet of paper P in the A direction is located at an intermediate position between two adjacent opening groups 82 included in the determined pattern. Then, it is desirable to supply the paper P to the first transport belt 8.

A case where the paper P to be used has a size of 13 inches×19.2 inches is described. In this case, as shown in FIG. 12, on the first transport belt 8, the control unit 110 controls the resist roller pair 13 to supply the paper P to the first transport belt 8 at a specific supply timing so that one sheet of paper P is arranged between the opening group 82A and the opening group 82D, and one sheet of paper P is arranged between the opening group 82D and the opening group 82A. In the example of FIG. 12, two sheets of paper P can be conveyed in one cycle of the first conveying belt 8, and a productivity of 60 ipm can be achieved.

As described above, the control unit 110 determines the pattern (combination) in the A direction of the plurality of opening groups 82 used at the time of flushing according to the size of the paper P to be used. As a result, no matter what size of paper P is used, as much paper P as possible can be arranged on the first transport belt 8 so as not to overlap the opening group 82 arranged in the above pattern. Therefore, it is possible to avoid a decrease in productivity (decrease in the number of printed sheets) regardless of the size of the paper P used.

Further, during one cycle of the first transport belt 8, flushing can be performed a plurality of times by using a plurality of opening groups 82 located in the above pattern. Therefore, regardless of using any size of the paper P, insufficient flushing and resulting clogging of the nozzle (ink ejection port 18) can be reduced. In particular, the control unit 110 causes the recording head 17 to perform flushing at the timing when the opening group 82 located in the above pattern faces the recording heads 17a to 17c by the first transport belt 8 traveling. As a result, it is possible to reliably perform flushing a plurality of times during one cycle of the first transport belt 8 and prevent the insufficient flushing.

Further, since it is not necessary to reduce the transport speed of the paper P in order to eliminate the insufficient flushing, it is possible to contribute to the improvement of productivity in this respect as well. Further, since it is not necessary to change the transport speed of the paper P, complicated transport control of the paper P (complex drive control of the first transport belt 8) becomes unnecessary.

Further, in the present embodiment, the storage unit 28 stores the information on the size of the paper P input in advance by the operation panel 27, that is, the information on the size of the paper P transported by the first transport belt 8. Then, the control unit 110 recognizes the size of the paper P to be used based on the information stored in the storage unit 28, and it determines the pattern of the opening group 82 according to the recognized size. For example, the printer 100 can have a sensor that detects the size of the paper P to be used, and the control unit 110 can determine the pattern of the opening group 82 according to the size detected by the sensor. However, in this case, a dedicated sensor for detecting the size of the paper P is required. In the present embodiment, the control unit 110 recognizes the size of the paper P based on the information stored in the storage unit 28 and determines the above pattern. Therefore, the effect of the present embodiment can be obtained by determining the above pattern without separately providing a dedicated sensor for detecting the size of the paper P.

Further, the control unit 110 supplies the paper P from the resist roller pair 13 to the first transport belt 8 on the first transport belt 8. This is done so that at least one sheet of paper P is placed between the plurality of opening groups 82 arranged in the above pattern. In this case, even if the opening 80 becomes dirty, the paper P does not overlap the dirty opening 80 and is not conveyed. The case that the opening 80 becomes dirty is when the ink ejected from the recording heads 17a to 17c adheres to the opening 80 of the opening group 82 during flushing, or the like. As a result, it is possible to reduce the situation where the paper P gets dirty due to the ink stain of the opening 80.

Further, on the first transport belt 8, the paper P is located at a distance of a specific distance or more in the A direction from the opening group 82. As a result, the following situations can be dealt with. For example, this is a case where the ink ejected from the recording heads 17a to 17c during flushing deviates and progresses in the A direction from the path toward the opening group 82 for some reason. Some reason for this is, for example, the effect of negative pressure suction on paper P. Then, even if the ink collides with the periphery of the opening 80 of the opening group 82 and is scattered around, that is, even if a splash is generated, the scattered ink is difficult to reach the paper P. Therefore, it is possible to reduce the situation where the paper P is soiled due to the splash of ink during flushing. In addition, the specific distance may appropriately be set according to the viscosity of the ink, the suction force of the paper P (the driving force of the suction member 53 described above), the traveling speed of the first transport belt 8 (the transport speed of the paper P), and the like. That is, it is not limited to the above 10 mm.

Further, in the present embodiment, the control unit 110 determines the timing of supplying the paper P to the above-mentioned position between the plurality of opening groups 82 on the first transport belt 8 based on the detection result of the belt sensor 24 or 25. The control unit 110 supplies the paper P from the resist roller pair 13 to the first transport belt 8 at the determined timing. The above position is a position separated from the opening group 82 in the A direction by equals to or more than a specific distance. As a result, the resist roller pair 13 reliably supplies the paper P to the above-mentioned position between the opening group 82 and the opening group 82 of the first transport belt 8. Then, the above-mentioned effect can be surely obtained.

Further, in the present embodiment, as described above, the control unit 110 takes the detection result of the belt sensor 24 or 25 in each cycle of the first transport belt 8 for each class determined according to the size of the paper P. Flushing in the recording heads 17a to 17c is controlled so that the ink passes through the same opening group 82. In this case, in each cycle of the first transport belt 8, the other opening group 82 is not contaminated with the ink at the time of flushing. Therefore, for any class of paper P, there is no concern that the paper P becomes dirty even if it is transported so as to overlap with the other opening group 82 in each cycle of the first transport belt 8, and such paper P can be transported. That is, for any class of paper P, the opening group 82 through which the ink during flushing passes is avoided and placed in each cycle, and the paper P can be conveyed without being dirty.

Further, in the present embodiment, as shown in FIG. 9, a case where one paper P is supplied from the resist roller pair 13 between the opening group 82F and the opening group 82A adjacent to each other in the A direction is considered. In this case, the control unit 110 sets the center Po of the paper P in the A direction at an intermediate position 8m between the two adjacent opening groups 82F and 82A of the first transport belt 8. Then, the control unit 110 supplies the paper P from the resist roller pair 13 to the first transport belt 8. At this time, the control unit 110 controls the resist roller pair 13 based on the detection result of the belt sensor 24 or 25.

In this case, on the first transport belt 8, both the front end (downstream end in the A direction) and the rear end (upstream end in the A direction) of the paper P are separated by an equal distance, which is from the opening group 82F located on the downstream side and the opening group 82A located on the upstream side with respect to the paper P. As a result, the following situations can be dealt with. That is, a situation in which ink ejected from the recording heads 17a to 17c during flushing and traveling deviating from the path toward one opening group 82F or the other opening group 82A collides with the periphery of the opening 80 and scatters. Even in this case, it becomes difficult for the scattered ink to reach the front and rear edges of the paper P. Therefore, it is possible to reliably reduce the situation where the paper P is soiled due to the splash of ink.

Further, in the present embodiment, as shown in FIGS. 9 to 12, the control unit 110 supplies the paper P from the resist roller pair 13 to the first transport belt 8 at regular intervals. In this case, since the supply of the paper P from the resist roller pair 13 to the first transport belt 8 may be controlled at a fixed timing, the supply control of the paper P (control of the resist roller pair 13) becomes easy.

Further, in the present embodiment, the first transport belt 8 further has a suction hole 8a in addition to the above-mentioned opening 80. Then, in the first transport belt 8, the size of the opening 80 (opening area) is larger than the size of the suction hole 8a (opening area). For example, if the suction hole 8a is large, there is a concern that ink ejected from the recording heads 17a to 17c may be splashed during flushing. This is a case where deviating from the direction toward the opening 80 to the suction hole 8a and colliding with the periphery of the opening 80. However, since the suction hole 8a is relatively smaller than the opening 80, the occurrence of the above-mentioned splash can be further reduced. Therefore, it is possible to further reduce the stain on the paper P due to the splash.

Further, the opening group 82 of the first transport belt 8 is irregularly positioned in the A direction in one cycle of the first transport belt. In this case, the effect of the present embodiment described above can be obtained by using the first transport belt 8 in which the minimum necessary opening groups 82 corresponding to the sizes of the plurality of sheets P are arranged in the A direction. Further, by minimizing the number of the opening group 82, it is easy to secure the strength of the first transport belt 8.

Further, as shown in FIG. 9, the A4 size (horizontal placement) and the letter size (horizontal placement) belong to the same class (first class). Then, in this class, the opening group 82 used for flushing is a constant pattern of the opening groups 82A, 82C, and 82F. Further, as shown in FIG. 10, the A4 size (vertical placement) and the letter size (vertical placement) belong to the same class (second class). Then, in this class, the opening group 82 used for flushing is a constant pattern of the opening groups 82A and 82D. Further, as shown in FIG. 11, A3 size, B4 size, or legal size (all vertical placement) are classified to the same class (third class). Then, in this class, the opening group 82 used for flushing is a constant pattern of the opening groups 82A, 82B, and 82E. Further, as shown in FIG. 12, the size of 13 inches×19.2 inches independently classifies one class (fourth class). Then, in this class, the opening group 82 used for flushing is a constant pattern of the opening groups 82A and 82D.

As described above, the pattern of the opening group 82 used at the time of flushing is a constant pattern for each class determined according to the size of the paper P. In this case, at the time of flushing, the control unit 110 may perform ink ejection control in the recording heads 17a to 17c in a pattern corresponding to the pattern of the opening group 82 for each class. Therefore, the discharge control becomes easy.

Further, the patterns of the opening group 82 used at the time of flushing are different from each other in FIGS. 9 and 10, FIGS. 10 and 11, and FIGS. 11 and 12. On the other hand, the above pattern is the same in FIGS. 10 and 12. Thus, it can be said that the above pattern is different between at least two classes determined according to the size of the paper P. By setting such a pattern, flushing can be performed for any size (class) of paper P by using the opening group 82 of an appropriate pattern without reducing the productivity.

Further, in the first transport belt 8, the opening group 82 has a plurality of opening rows 81 in the A direction. Then, the opening 80 of any of the opening rows 81 (for example, the opening row 81a) is positioned so as to be offset from the opening 80 of the other opening row 81 (for example, the opening row 81b) in the belt width direction. Moreover, it is positioned so as to overlap a part of the opening 80 of the other opening row 81 when viewed in the A direction. In this case, ink is ejected from the nozzles (ink ejection ports 18) at any position in the width direction of the recording heads 17a to 17c, and an opening at any position in the belt width direction in the first transport belt 8. Flushing can be performed by passing through the unit 80. Therefore, clogging of the nozzles can be reduced or prevented for the nozzles at all positions in the width direction.

Further, in the first transport belt 8, the plurality of openings 80 of the opening row 81 are located at equal intervals in the belt width direction. In this configuration, by deviating and being positioned the plurality of opening rows 81 in the belt width direction, it becomes easy to superimpose a part of the openings 80 of the adjacent opening rows 81 when viewed in the A direction. Therefore, the first transport belt 8 having such a configuration can easily be manufactured.

Further, in the present embodiment, the first transport belt 8 possesses six opening groups 82 in the A direction in one cycle. In this case, for the four classes classified according to the size of the paper P, it is possible to generate a pattern in the A direction of the opening group 82 that does not reduce the productivity. In addition, the first transport belt 8 may have seven or more opening groups 82 in the A direction in one cycle. In this case, a pattern in the A direction of the opening group 82 that does not reduce the productivity can be generated for five or more classes classified according to the size of the paper P.

(3-3. Other Configuration Example of the First Transport Belt)

FIG. 13 is a plan view showing another configuration example of the first transport belt 8. The first transport belt 8 may have a configuration in which the above-mentioned opening group 82 is located at equal intervals in the transport direction of the first transport belt 8, that is, in the A direction. At this time, the two openings 82 adjacent to each other in the A direction are located at intervals shorter than the length of the paper P in the A direction when the minimum printable size paper P is placed on the first transport belt 8. Further, in the configuration of FIG. 13, the opening 80 configuring the opening group 82 also serves as the suction hole 8a in the configuration of FIG. 8. In addition, the point that the opening group 82 has a plurality of opening rows 81 and the point that one opening row 81 has a plurality of openings 80 arranged at equal intervals in the BB′ direction are the same as the first transport belt 8 as shown in FIG. 8, and the like.

Even when the first transport belt 8 shown in FIG. 13 is used, the control unit 110 determines the pattern in the A direction of the plurality of opening groups 82 used for flushing, depending on the size of the paper P to be used, as similar to the case where the first transport belt 8 as shown in FIG. 8 is used. For example, when the paper P to be used is A4 size (horizontal placement) or letter size (horizontal placement), the control unit 110 selects the pattern of the opening group 82 as shown in FIG. 14. When the paper P to be used is A4 size (vertical placement) or letter size (vertical placement), the control unit 110 selects the pattern of the opening group 82 as shown in FIG. 15. When the paper P to be used is A3 size, B4 size or legal size (all vertical placement), the control unit 110 selects the pattern of the opening group 82 as shown in FIG. 16. When the paper P to be used has a size of 13 inches×19.2 inches, the control unit 110 selects the pattern of the opening group 82 as shown in FIG. 17. In addition, in FIGS. 14 to 17, for convenience, the opening group 82 located at the position corresponding to the opening groups 82A to 82F in FIG. 8 is shown as the opening groups 82A to 82F.

Then, the control unit 110 causes the recording heads 17a to 17c to perform flushing at the timing when the opening group 82 located in the determined pattern faces the recording heads 17a to 17c by the traveling of the first transport belt 8.

Further, the control unit 110 supplies the paper P to the positions as shown in FIGS. 14 to 17 on the first transport belt 8 by the resist roller pair 13. The positions as shown in FIGS. 14 to 17 are between a plurality of opening groups 82 arranged in the A direction in the above pattern. At this time, the control unit 110, on the first transport belt 8, controls the resist roller pair 13 to supply the paper P to the first transport belt 8 so as that each paper P is arranged at a position separated by equal to or more than a specific distance in the A direction from the opening group 82 located in the above pattern. The A direction includes both the upstream side and the downstream side.

As described above, even when the first transport belt 8 shown in FIG. 13 is used, the control unit 110 performs the similar controls as when the first transport belt 8 shown in FIG. 8 is used. Here, the similar controls include flushing control and paper P supply control. As a result, no matter what size of paper P is used, a decrease in productivity is avoided. In addition, clogging of the nozzle due to insufficient flushing can be reduced. The same effects as described above, or the like, can be obtained.

In particular, a configuration in which the opening groups 82 are located at equal intervals in the A direction of the first transport belt 8 can be easily realized by making holes at regular intervals in the A direction with respect to the first transport belt 8. Therefore, the first transport belt 8 can be easily manufactured, and the manufacturing cost thereof can be reduced.

Further, in the configuration in which the opening 80 of the first transport belt 8 also functions as the suction hole 8a shown in FIG. 8, the opening area of the opening 80 equals the opening area of the suction hole 8a. As a result, only one type of hole size is required to be formed in the first transport belt 8. In this respect as well, the first transport belt 8 is easier to manufacture than the configuration of FIG. 8. This is because, in FIG. 8, two types of holes having different sizes are required to be formed.

In addition, in the configuration in which the paper P is transported by the first transport belt 9 by the negative pressure suction method, the first transport belt 8 may have the configuration shown in FIG. 8 or the configuration as shown in FIG. 13. This has the effect of reducing nozzle clogging due to insufficient flushing while avoiding a decrease in productivity, or the like. Therefore, the configurations of FIGS. 8 and 13 are summarized. Then, in the first transport belt 8, it can be said that the size of the opening 80 may be larger than the size of the suction hole 8a.

In addition, in the first transport belt 8 having the configuration as shown in FIG. 13, innumerable openings 80 for flushing are formed over the entire surface of the belt. Therefore, the productivity can be remarkably improved by packing and transporting the paper P in the A direction on the first transport belt 8 and flushing by using the opening 80 at a position where the paper P does not overlap with the paper P. However, when the paper P is conveyed in this way, the opening 80 and the conveyed paper P tend to overlap each other in each cycle of the first conveying belt 8. At the opening 80, which is contaminated by the passage of ink during flushing, the paper P is easily contaminated.

Even in the configuration using the first transport belt 8 of FIG. 13, as described above, the pattern of the opening group 82 used for flushing is determined according to the size of the paper P. Then, flushing is performed using the opening group 82 located in the determined pattern. As a result, flushing can be performed by using the same opening group 82 in each cycle. At the same time, the paper P can be arranged and conveyed at a position deviated from the opening group 82 used for flushing. As a result, the paper P is conveyed over a plurality of cycles while ensuring productivity. Then, it is possible to reduce the stain on the paper P when printing. In this respect, the flushing control and the paper P supply control described in the present embodiment are effective even when the first transport belt 8 having the configuration shown in FIG. 13 is used.

In addition, when the paper P is conveyed by the first transfer belt 8 as shown in FIG. 13, the pattern of the opening group 82 used at the time of flushing may be a pattern different from the pattern when the first transport belt 8 shown in FIG. 8 is used. For example, flushing may be performed on the opening group located between the paper P and the paper P conveyed at the positions shown in FIGS. 14 to 17.

[4. Flushing Control Based on Opening and Paper Detection]

As described above, in the present embodiment, the control unit 110 performs to control the first transport belt 8 to supply a plurality of sheets of paper P by the resist roller pair 13 based on the detection result of the belt sensor 24 or 25. In this control, at least one sheet of paper P is placed between the two opening groups 82 located in a preset pattern on the first transport belt 8 (as refer to, for example, FIGS. 9 and 14). On this basis, with respect to the reference opening group (for example, opening group 82A) on the first transport belt 8, the tip of the leading paper P is set to come to a specific position (a position deviated from the opening group 82A by 10 mm in the A direction). Such control of the control unit 110 is also referred to as a first control here.

However, even if the control unit 110 performs the first control, as shown in FIG. 18, the leading paper P may deviate from a specific position with respect to the reference opening group 82A on the first transport belt 8. This is caused by, for example, slipping of the paper P on the resist roller pair 13, slipping of the first transport belt 8 on the driving roller 6a, the driven roller 6b and the other rollers 7, and rotation fluctuation of the motor driving the driving roller 6a, or the like. When the leading paper P deviates from the specific mounting position in this way, there is a possibility that the subsequent paper P may be appear on the paper P that overlaps with the opening group 82 used for flushing. In the example of FIG. 18, the state in which the second, fourth, and fifth sheets of paper P from the beginning are placed so as to overlap with the opening groups 82C, 82F, and 82A used for flushing, respectively, is shown. In such a case, consider a case where the recording heads 17a to 17c are flushed at a timing facing the opening groups 82C, 82F, and 82A. Then, the ink ejected from the recording heads 17a to 17c lands on the paper P overlapping the opening groups 82C, 82F, and 82A, respectively. Thus, the image quality of the images recorded on these sheets P is impaired.

Therefore, in the present embodiment, even if the placement position of the paper P on the first transport belt 8 deviates from the regular position due to the slippage of the paper P, or the like, as described above, the second control is performed. As a result, the deterioration of the image quality of the recorded image due to the impact of the ink ejected by flushing on the paper P is avoided. Hereinafter, an example of the second control is described.

(4-1. Flushing Control (1))

FIG. 19 is a flowchart showing an operation flow according to an example of the second control of the present embodiment. In addition, for here, as an example, it is assumed that the paper P used is A4 size (horizontally placed). Firstly, the belt sensor 24 detects the passage of the reference opening group 82A in the first transport belt 8 (S1). Next, the second paper sensor 23 detects the passage of the tip of the paper P supplied to the first transport belt 8 by the resist roller pair 13 (S2).

Next, the control unit 110 determines whether or not the tip of the leading paper P actually supplied to the first transport belt 8 is at a specific position (S3). This determination is made based on each of the detection results of the belt sensor 24 and the second paper sensor 23. The specific position is the position with respect to the reference opening group 82A. Further, the specific position is a position deviated from the opening group 82A by 10 mm in the transport direction. Specifically, such a judgment can be made as follows.

For example, FIG. 20 is an explanatory diagram showing the detection timing of each sensor. It is assumed that the belt sensor 24 (first belt sensor) detects the passage of the reference opening group 82A by the traveling of the first transport belt 8 at time t1. The control unit 110 drives the resist roller pair 13 after a lapse of a specific time from time t1 to supply the paper P to the first transport belt 8. At this time, if the second paper sensor 23 (first detection sensor) detects the passage of the tip of the paper P at time t3, it is assumed that the paper P does not slip on the resist roller pair 13 and the paper P is placed at a specific position on the first transport belt 8. Actually, when the paper P is slipped on the resist roller pair 13, the second paper sensor 23 detects the passage of the tip of the paper P at a time t3a, which is later than the time t3. Therefore, if the value of |t3a−t3| is larger than the threshold value, the control unit 110 can determine that the supply of the paper P to the first transport belt 8 is delayed due to the slip of the paper P on the resist roller pair 13. That is, the control unit 110 can determine that the tip of the paper P is deviated from the regular position in the transport direction with respect to the reference opening group 82A (exceeding the allowable range of deviation). On the contrary, if the value of |t3a−t3| is equal to or less than the threshold value, the control unit 110 can determine that the paper P is normally supplied to the first transport belt 8 with almost no slippage of the paper P on the resist roller pair 13. In this case, the control unit 110 can determine that the tip of the paper P does not deviate from the regular position with respect to the reference opening group 82A (even if there is a deviation, it is within the permissible range).

Further, if the belt sensor 25 (second belt sensor) detects the passage of the reference opening group 82A at time t2, it is assumed that the first transport belt 8 does not slip with the roller (for example, the drive roller 6a) that stretches the first transport belt 8. Then, it is assumed that the paper P can be placed at a specific position with respect to the opening group 82A. Actually, if the first transport belt 8 is slippery, the belt sensor 25 detects the passage of the opening group 82A at a time t2a, which is later than the time t2. Therefore, if the value of |t2a−t2| is larger than the threshold value, the control unit 110 can determine that the paper P cannot be placed at a specific position with respect to the opening group 82A due to the slippage of the first transport belt 8. In this case, the control unit 110 can determine that the tip of the paper P is deviated from the regular position in the transport direction with respect to the reference opening group 82A. That is, the control unit 110 can determine that the deviation tolerance range is exceeded. On the contrary, if the value of |t2a−t2| is equal to or less than the threshold value, the control unit 110 can determine that the first transport belt 8 has almost no slippage. In this case, the control unit 110 can determine that the tip of the paper P supplied to the first transport belt 8 does not deviate from the regular position with respect to the reference opening group 82A. That is, the control unit 110 can determine that the deviation is within the allowable range.

A case where it is determined in S3 that the tip of the leading paper P actually supplied to the first transport belt 8 is at a specific position with respect to the reference opening group 82A (Yes in S3) is described. In this case, the control unit 110 causes the recording heads 17a to 17c to execute flushing as shown in FIG. 9 (S4). This is executed at the timing when the opening groups 82A, 82C, and 82F located in the initial pattern determined according to the size of the paper P face the recording heads 17a to 17c. On the other hand, when it is determined in S3 that the tip of the leading paper P is not at a specific position with respect to the opening group 82A (No in S3), the control unit 110 stops the execution of flushing by the recording heads 17a to 17c (S5). Then, a series of flushing controls are terminated.

As described above, the control unit 110 determines whether or not the tip of the leading paper P actually supplied to the first transport belt 8 is at a specific position with respect to the reference opening group 82A. Then, the control unit 110 performs a second control for controlling flushing based on the determination result (S3 to S5). Thus, when the tip of the leading paper P is at a specific position, flushing is performed at a specific timing thereafter. As a result, clogging of the ink ejection port 18 is reduced. On the other hand, if it is not in a specific position, flushing is stopped. As a result, deterioration of the image quality of the image recorded on the paper P can be avoided. That is, the execution of flushing is controlled based on the actual placement state of the paper P on the first transport belt 8. Therefore, even when the paper P is placed with respect to the opening 80 (opening group 82) of the first transport belt 8 at a position deviated from the regular position, the productivity is not lowered. That is, it is possible to avoid deterioration of the image quality of the recorded image due to flushing while continuously supplying a plurality of sheets of paper P to the first transport belt 8.

In particular, in the second control, the control unit 110 determines that the tip of the leading paper P actually supplied to the first transport belt 8 is not at a specific position with respect to the reference opening group 82A. In this case, the control unit 110 stops flushing by the recording heads 17a to 17c (S3, S5). If the tip of the first paper P actually supplied is not at a specific position with respect to the reference opening group 82A, the subsequent paper P may overlap with opening groups 82C, 82F, and 82A used for flushing (see FIG. 18). In such a case, flushing is stopped. As a result, it is possible to prevent the ink ejected by flushing from landing on the paper P overlapping the opening groups 82C, 82F, and 82A. Therefore, it is possible to reliably avoid a situation in which the image quality of the recorded image on the paper P deteriorates.

(4-2. Flushing Control (2))

FIG. 21 is a flowchart showing an operation flow according to another example of the second control of the present embodiment. Since S1 to S4 are the same as those in FIG. 19, the description thereof is omitted. A case where it is determined in S3 that the tip of the leading paper P is not at a specific position with respect to the opening group 82A (No in S3) is described. In this case, the control unit 110 estimate, among the openings 82 at a plurality of locations in the transport direction of the first transport belt 8, a specific opening group 82 located offset from the paper P supplied on the first transport belt 8 in the transport direction (S6).

FIG. 22 shows the opening group 82 used when flushing is performed by the second control in black. In FIG. 22, the opening group 82D corresponds to a specific opening group 82 located offset from the paper P supplied on the first transport belt 8 in the transport direction. In addition, the position information of the opening groups 82 at a plurality of locations on the first transport belt 8 (separation distance of each opening group 82), the size of the paper P, the supply interval of the paper P, and the traveling speed of the first transport belt 8 (=Supply speed of paper P by resist roller pair 13) is understandable. Therefore, the control unit 110 can calculate the amount of deviation of the tip of the paper P from a specific position based on the traveling speed of the first transport belt 8 and the time difference |t2a−t2| and |t3a−t3|). Sequentially, the control unit 110 can estimate a specific opening group 82 located offset from the paper P in the transport direction on the first transport belt 8 based on the calculated amount of deviation. For example, when the traveling speed of the first transport belt 8 is V(mm/sec), the deviation amount d(mm) can be calculated by V×(|t2a−t2|−|t3a−t3|). Therefore, the control unit 110 can estimate the opening group 82 that overlaps with the paper P that is deviated from the regular mounting position by the amount d in the transport direction on the first transport belt 8. Further, among the opening groups 82 at a plurality of locations, the remaining opening group 82 excluding the opening group 82 overlapping the paper P can be estimated as the specific opening group 82.

The control unit 110 estimates a specific opening group 82 in S6. Then, the control unit 110 causes the recording heads 17a to 17c to perform flushing at the timing when the estimated specific opening group 82 faces the recording heads 17a to 17c (S7). For example, the control unit 110 causes the recording heads 17a to 17c to perform flushing at the timing when the reference opening group 82A faces the recording heads 17a to 17c. After that, the recording heads 17a to 17c are flushed at the timing when the specific opening group 82D faces the recording heads 17a to 17c. Due to such flushing control, in the example of FIG. 22, flushing using the opening groups 82C, 82F, 82A (second cycle) located in a preset pattern according to the size of the paper P is not performed.

As described above, in the case of No in S3, the control unit 110 executes flushing at the timing when the specific opening group 82D faces the recording heads 17a to 17c (S6, S7). The specific opening group 82D is located among the opening group 82 of a plurality of locations so as to be offset from the paper P in the transport direction. As a result, the ink discharged during flushing passes through the specific opening group 82D that does not overlap with the paper P in the first transport belt 8. That is, it is possible to prevent the ink from landing on the paper P. Therefore, even if the placement position of the paper P with respect to the first transport belt 8 deviates due to the sliding of the rollers, or the like, it is possible to reliably avoid the situation where the image quality of the recorded image of the paper P deteriorates due to flushing.

In particular, the specific opening group 82D is an opening group 82 located between two sheets P adjacent to each other in the transport direction on the first transport belt 8. In this case, by a so-called inter-sheet flushing, while reducing the clogging of the ink discharge ports 18, the field of the recorded image while avoiding the decrease in productivity can be avoided quality degradation.

Further, the control unit 110 estimates a specific opening group 82 based on the amount of deviation of the tip of the leading paper P from the specific position (S6). As a result, the specific opening group 82 used for flushing can be estimated accurately, and flushing can be performed accurately by using the estimated specific opening group 82.

FIG. 23 shows an example of the opening group 82 and the opening row 81 used when flushing is performed by the second control. As shown in black in the figure, in S6, in addition to the specific opening group 82D described above, the control unit 110 may execute flushing at a timing when the specific opening row 81 faces the recording heads 17a to 17c. The specific opening row 81 is positioned on the first transport belt 8 so as to be offset from the paper P in the transport direction. Here, the specific opening row 81 is assumed an opening row located on the first transport belt 8 so as to be offset from the paper P in the transport direction among the plurality of opening rows 81 configuring the opening group 82E. Even in this case, the ink discharged at the time of flushing passes through the specific opening row 81 that does not overlap with the paper P in the first transport belt 8, and it is possible to prevent the ink from landing on the paper P. Therefore, even if the placement position of the paper P with respect to the first transport belt 8 deviates due to the sliding of the rollers or the like, it is possible to reliably avoid the situation where the image quality of the recorded image of the paper P deteriorates due to flushing. Further, the specific opening row 81 is an opening row 81 located between two sheets P adjacent to each other in the transport direction on the first transport belt 8. Therefore, even in the inter-paper flushing by using the specific opening row 81, it is possible to reduce the clogging of the ink ejection port 18 and avoid the deterioration of the image quality of the recorded image while avoiding the reduction of the productivity.

FIGS. 24 and 25 are examples of the opening group 82 in the configuration by using the first transport belt 8 as shown in FIG. 13. In this example, the opening group 82 is used when inter-paper flushing between two sheets of paper P to be placed. Further, FIG. 24 shows a case where the leading paper P is placed at a regular position with respect to the reference opening group 82. FIG. 25 shows a case where the leading paper P is placed at a position deviated from the regular position with respect to the reference opening group 82. Even when the first transport belt 8 having the configuration as shown in FIG. 13 is used, the positions of the opening groups 82 at a plurality of locations, the traveling speed of the first transport belt 8, and the like, is understood. Therefore, the amount of deviation of the tip of the paper P from a specific position can be calculated based on the traveling speed of the first transport belt 8 and the time difference |t2a−t2| and |t3a−t3|. Further, based on the calculated amount of deviation, it is possible to estimate a specific opening group 82 located offset from the paper P in the transfer direction on the first transfer belt 8. Then, the control unit 110 can make the recording heads 17a to 17c perform flushing by using the specific opening group 82 located between the paper P and the paper P. As a result, the same effect as described above can be obtained.

(4-3. Flushing Control (3))

FIG. 26 is a flowchart showing an operation flow according to still another example of the second control of the present embodiment. Since 51 to S4 are the same as those in FIG. 19, the description thereof is omitted. If it is determined in S3 that the tip of the leading paper P is not at a specific position with respect to the opening group 82A (No in S3), the control unit 110 determines whether or not the specific printing is completed (S6-1). Then, if it is determined that printing is completed, at the timing when the specific opening group 82 located on the upstream side in the transport direction from the last paper P on which the specific printing is performed faces the recording heads 17a to 17c, the control unit 110 causes the recording heads 17a to 17c to execute flushing (S7-1).

Here, in S6-1, the “specific printing” can be assumed to be printing a specific number of sheets or printing a plurality of sheets included in one printing job.

The opening group 82 located on the upstream side in the transport direction from the last paper P on which the specific printing is performed is not supplied with the paper P to the first transport belt 8 until the start instruction of the next printing job is given. Thus, the papers P do not overlap. Therefore, by flushing using the opening group 82, the ink ejected by the flushing passes through the opening group 82 on the first transport belt 8 and does not land on the paper P. Therefore, by performing such a second control by the control unit 110, the following effects can be obtained: Even if the placement position of the paper P on the first transport belt 8 deviates due to slippage of the rollers or the like, clogging of the ink ejection port 18 is prevented by executing flushing. At the same time, it is possible to reliably avoid the deterioration of the image quality of the image recorded on the paper P while avoiding the deterioration of the productivity. In addition, the opening group 82 used for flushing may be the opening group 82 included in a preset pattern according to the size of the paper P. Alternatively, the opening group 82 may be an opening group 82 other than the above pattern.

(4-4. Flushing Control (4))

FIG. 27 is a flowchart showing an operation flow according to still another example of the second control of the present embodiment. Since S1 to S4 are the same as those in FIG. 19, the description thereof is omitted. A case where it is determined in S3 that the tip of the leading paper P is not at a specific position with respect to the opening group 82A (No in S3) is described. In this case, the control unit 110 determines whether or not the tip of another paper P has reached a specific position with respect to the reference opening group 82A by traveling the first conveyor belt 8 in a plurality of cycles (S6-2). This another paper P is different from the first paper P. Then, if the control unit 110 determines that the tip of another sheet P has come to the specific position, the control unit 110 causes the recording heads 17a to 17c to flush at the timing when the reference opening group 82A faces the recording heads 17a to 17c (S7-2). That is, in such a second control, the specific opening group 82 is the opening group 82A that serves as the reference when the specific opening group 82 comes to the specific position. Here, the specific opening group 82 is positioned so as to deviate from the paper P supplied on the first transport belt 8 in the transport direction. The specific position is a position to which the tip of another paper P may come with respect to the reference opening group 82A due to the traveling of the first transport belt 8 in a plurality of cycles.

If the placement position of the paper P with respect to the first transfer belt 8 is displaced due to slippage of the rollers or the like, the deviation of the placement position is accumulated when the first transfer belt 8 travels for a plurality of cycles. As a result, the tip of another sheet P may come to a specific position with respect to the reference opening group 82A. The specific position is, for example, a position deviated by 10 mm in the transport direction with respect to the opening group 82A. Therefore, when flushing is performed at the timing when the opening group 82A when the tip of another paper P comes to the specific position faces the recording heads 17a to 17c, the ejected ink passes through the opening group 82A. Thus, landing on another sheet P is avoided. Therefore, even if such a second control is performed, clogging of the ink ejection port 18 can be prevented by flushing. At the same time, it is possible to reliably avoid the deterioration of the image quality of the recorded image of the paper P due to flushing while avoiding the deterioration of the productivity.

(4-5. Flushing Control (No. 5))

FIG. 28 is a flowchart showing an operation flow according to still another example of the second control of the present embodiment. The control unit 110 may switch the flushing control to any of the controls described in the above 1 to 4 according to the print mode of the apparatus set on the operation panel 27 (as refer to FIG. 4).

For example, it is assumed that the low image quality mode, the print priority mode, and the image quality priority mode can be set by the operation panel 27 as the print mode of the apparatus. The low image quality mode is a print mode that is set when there is no problem even if the image quality is lowered, for example, when the print target is a document (text data). The print priority mode is a print mode that emphasizes productivity. The image quality priority mode is a mode in which printing is performed while ensuring good print quality.

For example, if the control unit 110 determines that the print mode set by the operation panel 27 is the low image quality mode (Yes in S11), the control unit 110 executes the flushing control (No. 1) described above (S12). That is, the control unit 110 controls in S3 to stop flushing if it is determined in S3 that the tip of the leading paper P is not at a specific position with respect to the reference opening group 82A. In the low image quality mode, image quality is not pursued, so there is no need to force flushing. In this case, flushing can be stopped and ink consumption due to flushing can be suppressed.

Further, if the control unit 110 determines that the print mode set by the operation panel 27 is not the low image quality mode (No in S11) but the print priority mode (Yes in S13), the control unit 110 executes the flushing control (No. 4) as described above (S14). That is, a case where the control unit 110 determines in S3 that the leading edge of the leading sheet P is not at a specific position with respect to the reference opening group 82A is described. In this case, the control unit 110 causes the recording heads 17a to 17c to perform flushing by using the opening group 82A which is the reference if the tip of another paper P different from the leading paper P comes to a specific position with respect to the reference opening group 82A due to the traveling of the first transport belt 8 in a plurality of cycles. In the print priority mode, productivity is emphasized. Therefore, by the above control, it is possible to secure productivity by giving priority to printing on a plurality of sheets of paper P while reducing the number of flushing as much as possible.

Further, when the print mode set by the operation panel 27 is not the print priority mode (No in S13), the control unit 110 determines that the print mode is the image quality priority mode (S15). In this case, the control unit 110 executes the flushing control (No. 2) described above (S16). That is, if the control unit 110 determines in S3 that the tip of the leading paper P is not at a specific position with respect to the reference opening group 82A, the control unit 110 may control flushing as follows. The control unit 110 identifies an opening group 82 located offset in the transport direction from the misaligned paper P, and it causes the recording heads 17a to 17c to perform flushing by using such an opening group 82. In the image quality priority mode, good image quality can be maintained during the print job by flushing the openings 82 between the misaligned papers P while avoiding landing on the paper P.

In addition, in the image quality priority mode, the control unit 110 may perform the flushing control (No. 3) as described above. That is, if the control unit 110 determines in S3 that the tip of the leading paper P is not at a specific position with respect to the reference opening group 82A, the control unit 110 may control flushing as follows. The control unit 110 causes the recording heads 17a to 17c to perform flushing by using the opening group 82 located on the upstream side in the transport direction from the last paper P on which the specific printing is performed. In the image quality priority mode, it is desirable to perform flushing at least before the print job in order to achieve good image quality in each print job. Therefore, after the specific printing is completed, flushing is performed in preparation for the next printing job, so that good printing (ink ejection) can be performed in the next printing job.

As described above, the control unit 110 switches the flushing control based on the determination result of S3 in the second control according to the print mode set by the operation panel 27. As a result, appropriate flushing according to the print mode can be realized.

(4-6. Others)

In the present embodiment, in the first control, the control unit 110 determines the pattern of the plurality of opening groups 82 used at the time of flushing according to the size of the paper P. Then, the control unit 110 supplies a plurality of sheets of paper P to the first transport belt 8 at regular intervals by the resist roller pair 13 (see FIGS. 9 to 12 and 14 to 17). At this time, the control unit 110 sets the opening group 82 located in the determined pattern and the paper P supplied to the first transport belt 8 so as to be displaced in the transport direction. When performing such a first control, the placement position of the leading paper P with respect to the first transport belt 8 may deviate due to slippage on the rollers, or the like. In this case, the subsequent paper P is likely to be placed so as to overlap the opening group 82, and if flushing is performed at a normal timing, the image quality of the recorded image of the paper P deteriorates. Therefore, it can be said that the above-mentioned second control for avoiding the deterioration of image quality due to flushing is very effective especially in the configuration for performing the first control.

In particular, in the configuration using the first transport belt 8 of FIG. 8 in which the opening group 82 is irregularly located in the transport direction, the placement position of the leading paper P with respect to the reference opening group 82A on the first transport belt 8 is decided. Thereby, the placement position of the subsequent paper P is also determined. Therefore, the placement position of the leading paper P on the first transport belt 8 may deviate with respect to the reference opening group 82A due to slipping on the rollers, or the like. In this case, the subsequent paper P is likely to be placed so as to overlap the opening group 82, and if flushing is performed at a normal timing, the image quality of the recorded image of the paper P is likely to deteriorate. Therefore, the above-mentioned second control is very effective especially in the configuration by using the first transport belt 8 of FIG. 8.

Further, even in the configuration using the first transport belt 8 of FIG. 13 in which the opening group 82 is located at equal intervals in the transport direction of the first transport belt 8, it is considered a case where the placement position of the leading paper P with respect to the reference opening group 82A on the first transport belt 8 is displaced due to slippage on the rollers or the like. In this case, the subsequent paper P is placed so as to overlap the opening group 82, and the image quality of the recorded image is likely to deteriorate due to flushing. This point is the same as the case where the first transport belt 8 of FIG. 8 is used. Therefore, it can be said that the above-mentioned second control is very effective even in the configuration using the first transport belt 8 of FIG. 13.

In addition, as the above, the flushing control in the case where the paper P is placed on the first transport belt 8 so as to be deviated to the upstream side in the transport direction with respect to the reference opening group 82A has been described as an example. However, even when the paper P is placed offset to the downstream side in the transport direction with respect to the opening group 82, of course, the same effect as that of the present embodiment can be obtained by applying the same flushing control as that of the present embodiment.

In the above, the case where the paper P is attracted to the first transport belt 8 by negative pressure suction and transported is described. However, the first transport belt 8 may be charged and the paper P may be electrostatically attracted to the first transport belt 8 to be transported (electrostatic attracting method). Even in this case, the same effect as that of the present embodiment can be obtained by performing the flushing control and the supply control of the paper P to the first transport belt 8 as in the present embodiment.

In the above, an example in which a color printer that records a color image by using four colors of ink is used as an inkjet recording apparatus has been described. However, even when a monochrome printer that records a monochrome image by using black ink is used, the control described in the present embodiment can be applied.

Otherwise, in a sheet-fed machine that prints one sheet at a time on paper by ejecting ink, consider reducing nozzle clogging due to flushing, ensuring productivity (number of sheets printed on paper), and avoiding deterioration in image quality of images recorded on paper due to ink ejection. For this purpose, it is desirable to perform flushing between the sheet and the sheet placed on the transfer belt while supplying a plurality of sheets of paper on the transfer belt. To do so, it is necessary to control so that the opening used for flushing (hereinafter, also referred to as “opening for flushing”) is located between the paper and the paper placed on the transport belt. Therefore, it is necessary to control the timing of supplying the paper to the transport belt by the resist roller. That is, in this case, the position of the opening of the transport belt is detected. Then, based on the detection result, it is necessary to control the paper supply by the resist roller so that the paper is placed so as to be displaced from the opening in the transport direction.

On the other hand, when the paper is supplied to the transport belt by the resist roller, the feeding speed of the paper to the transport belt may change due to slippage on the resist roller. Then, even if the traveling speed of the transport belt is constant, the placement position of the paper on the transport belt deviates from the regular position where the paper is to be placed. Further, when the endless transport belt travels by the rotation of the tension roller, the traveling speed of the transport belt may change due to slippage on the tension roller or rotation fluctuation of the motor for driving the tension roller. Then, even if the speed of supplying the paper to the transport belt by the resist roller is constant, the placement position of the paper on the transport belt deviates from the regular position to be loaded.

In this way, when the paper placement position on the transport belt deviates from the regular position, among the plurality of papers supplied to the transport belt, the paper that is placed on the transport belt so as to overlap the flushing opening may appear. In this case, when flushing is performed at the timing when the flushing opening faces the recording head, the ink ejected by the flushing lands on the paper placed so as to overlap the flushing opening, and as a result, the image quality of the image recorded the above-mentioned paper in is degraded.

In this regard, in the typical technology, no method has been studied to avoid deterioration of the image quality of recorded images due to flushing in case that the paper placement position deviates from the regular position with respect to the opening of the transport belt due to slippage on various rollers, or the like.

According to the above configuration, the execution of flushing is controlled based on the mounting state of the recording medium actually supplied on the transport belt. Therefore, even when the recording medium is placed at a position deviated from the normal position with respect to the opening (group) of the transport belt, the productivity is not lowered. In addition to this, it is possible to avoid deterioration of the image quality of the recorded image due to flushing.

The present disclosure can be used in an inkjet recording apparatus that ejects ink to a storage medium and records an image.

What is claimed is:

1. An inkjet recording apparatus comprising:
a recording head with a plurality of nozzles that eject ink;
a control unit that causes the recording head to perform flushing to eject the ink at a timing different from timing that contributes to image formation on a recording medium;
an endless transport belt that conveys the recording medium to a position facing the recording head and having an opening group, which includes an opening that passes through the ink ejected from each nozzle of the recording head during the flushing, at a plurality of locations in the transport direction of the recording medium;
a recording medium supply unit that supplies the recording medium to the transport belt;
a first detection sensor that detects the passage of the recording medium supplied to the transport belt by the recording medium supply unit; and
a second detection sensor that detects the passage of at least one of the opening group due to the traveling of the transport belt; wherein
the control unit performs
a first control that supplies a plurality of recording media to the transport belt by the recording medium supply unit based on the detection result of the second detection sensor so that at least one recording medium is placed between two opening group located in a preset pattern on the transport belt and a tip of a leading recording medium comes to a specific position with respect to a reference opening group on the transport belt, and
a second control that determines whether or not the tip of the leading recording medium actually supplied to the transport belt is at the specific position with respect to the reference opening group based on the detection results of the first detection sensor and the second detection sensor and controls the flushing by the recording head based on the determination result.

2. The inkjet recording apparatus according to claim 1, wherein
the control unit, when determining in the second control that the tip of the leading recording medium actually supplied to the transport belt is not at the specific position with respect to the reference opening group, stops the flushing by the recording head.

3. The inkjet recording apparatus according to claim 1, wherein
the control unit, when determining in the second control that the tip of the leading recording medium actually supplied to the transport belt is not at the specific position with respect to the reference opening group, causes the recording head to perform the flushing at the timing when a specific opening group, which is among the opening groups of the plurality locations and is located offset in the transport direction to the recording medium supplied on the transport belt, faces the recording head.

4. The inkjet recording apparatus according to claim 3, wherein
the specific opening group is located between two recording media adjacent to each other in the transport direction on the transport belt.

5. The inkjet recording apparatus according to claim 3, wherein
the control unit, when determining in the second control that the tip of the leading recording medium actually supplied to the transport belt is not at the specific position with respect to the reference opening group, causes the recording head to perform the flushing at the timing when a specific opening row located offset in the transport direction from the recording medium supplied on the transport belt faces the recording head.

6. The inkjet recording apparatus according to claim 5, wherein
the specific opening row is located on the transport belt between two adjacent recording media in the transport direction.

7. The inkjet recording apparatus according to claim 3, wherein
the specific opening group is an opening group located on upstream side in the transport direction with respect to the last recording medium on which a specific printing is performed.

8. The inkjet recording apparatus according to claim 3, wherein
the specific opening group is the reference opening when tip of another recording medium comes to the specific position with respect to the reference opening group due to the traveling of the transport belt for a plurality of cycles.

9. The inkjet recording apparatus according to claim 3, wherein
the control unit estimates the specific opening group based on an amount of deviation of the tip of the leading recording medium from the specific position.

10. The inkjet recording apparatus according to claim 1,
further comprising an operation panel for setting a print mode of the recording apparatus, wherein
the control unit switches the flushing control based on the determination result in the second control according to the print mode set on the operation panel.

11. The inkjet recording apparatus according to claim 1, wherein
the control unit, in the first control, determines the pattern of a plurality of opening groups used in the flushing depending on the size of the recording medium and causes the recording medium supply unit to supply a plurality of the recording media to the transport belt at regular intervals so as to be positioned that the opening group located in determined pattern and the recording medium supplied to the transport belt are displaced in the transport direction.

12. The inkjet recording apparatus according to claim 1, wherein
the opening group is irregularly located in the transport direction in one cycle of the transport belt.

13. The inkjet recording apparatus according to claim 1, wherein
the opening group is located at equal intervals in the transport direction of the transport belt.
